(19) United States
(12) Patent Application Publication
(10) Pub. No.: US 2024/0070794 A1
(43) Pub. Date: Feb. 29, 2024

(54) USING MACHINE LEARNING TO IDENTIFY LEGAL OBLIGATIONS IN A DOCUMENT MANAGEMENT SYSTEM

(71) Applicant: DocuSign, Inc., San Francisco, CA (US)

(72) Inventors: Thierry Bonfante, Larkspur, CA (US); Robert Michael Johnson, Fort Collins, CO (US); Staci Leigh Black, Chicago, IL (US); Joyce Liang, Castro Valley, CA (US); Venkata Suresh Kumar Araveeti, Pleasanton, CA (US); Pratik Vinay Hatkar, Union City, CA (US); Radhika Kotangoor, McLean, VA (US); Sandesh Meda, Palatine, IL (US); Haitao Song, Sammamish, WA (US); Gor Vardanyan, San Antonio, TX (US)

(21) Appl. No.: 17/895,427

(22) Filed: Aug. 25, 2022

(51) Int. Cl. G06Q 50/18; G06F 16/93; G06N 5/02

(52) U.S. Cl. CPC G06Q 50/18; G06F 16/93; G06N 5/022

(57) ABSTRACT

A document management system uses machine learning to identify legal obligations within contract documents. The document management system trains a machine-learned model using historical contract documents having historical legal obligations; the trained machine-learned model is configured to identify portions of text within a contract document that correspond to legal obligations. The machine-learned model, applied to a set of contract documents, identifies a set of legal obligations. The document management system presents, via a user interface, information about the set of identified legal obligations.

### TECHNICAL FIELD

The disclosure generally relates to the field of document management, and specifically to using machine learning to identify legal obligations in a document management system.

### BACKGROUND

Online document management systems can be used to create and review documents, providing users with tools to edit, view, and execute the documents. Conventional systems require users to manually review terms and clauses in legal documents, which can be especially inefficient when there are large numbers of documents to review.

### SUMMARY

A method to help improve review of legal obligations in a set of documents is described herein.

A document management system generates a training set of data to train a machine-learned model. The training set of data includes a plurality of historical contract documents, each of which includes one or more portions of text corresponding to a historical legal obligation. Using the training set of data, the document management system trains a machine-learned model configured to identify portions of text within contract documents that correspond to legal obligations. The document management system accesses a set of contract documents associated with an entity and applies the machine-learned model to the accessed set of contract documents. The machine-learned model outputs portions of text within each contract document that correspond to a set of legal obligations. The document management system modifies an interface with the set of legal obligations.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a document management system, in accordance with an example embodiment.

FIG. 2 is a high-level block diagram of a system architecture of the document management system, in accordance with an example embodiment.

FIG. 3 illustrates training a machine-learned model configured to identify legal obligations within a set of contract documents, in accordance with an example embodiment.

FIG. 4 illustrates an example interface of the document management system that displays the legal obligations identified by the machine-learned model, in accordance with an example embodiment.

FIG. 5 illustrates an example process for identifying legal obligations in the set of contract documents, in accordance with an example embodiment.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. A letter after a reference numeral, such as “120A,” indicates that the text refers specifically to the element having that particular reference numeral. A reference numeral in the text without a following letter, such as “120,” refers to any or all of the elements in the figures bearing that reference numeral.

The figures depict embodiments of the disclosed system (or method) for purposes of illustration only. One skilled in the art will readily recognize from the following description that alternative embodiments of the structures and methods illustrated herein may be employed without departing from the principles described herein.

### Document Management System Overview

A document management system enables a party (e.g., individuals, organizations, etc.) to create and send documents to one or more receiving parties for negotiation, collaborative editing, electronic execution (e.g., via electronic signatures), contract fulfillment, archival, analysis, and more. For example, the document management system allows users of the party to create, edit, review, and negotiate document content with other users and other parties of the document management system.

The system environment described herein can be implemented within the document management system, a document execution system, or any type of digital transaction management platform. It should be noted that although description may be limited in certain contexts to a particular environment, this is for the purposes of simplicity only, and in practice the principles described herein can apply more broadly to the context of any digital transaction management platform. Examples can include but are not limited to online signature systems, online document creation and management systems, collaborative document and workspace systems, online workflow management systems, multi-party communication and interaction platforms, social networking systems, marketplace and financial transaction management systems, or any suitable digital transaction management platform.

The methods described herein improve document review processes in a document management system. A user of the document management system may oversee a number of contract documents for an entity, such as service agreements, rental agreements, employment contracts, and so on. Each of these contract documents may include legally binding obligations (e.g., promises to perform a set of actions). As a signee to a contract, the user and/or entity may be bound to perform a legal obligation, or, in some instances, owed certain legal obligations from counter parties to the contract. With conventional document management systems, the user is required to manually review each individual document and flag sections corresponding to legal obligations. Even if the user is familiar with the entity's legal obligations, document review is necessary in case of non-standard terms and obligations. These techniques are inefficient, time intensive, and prone to human error, potentially exposing the user and entity to greater costs and legal liability.

The methods described herein improve document review processes in the document management system. Specifically, the document management system identifies legal obligations included within a set of contract documents, and populates an interface displayed via the document management system with information representative of the identified legal obligations, beneficially providing a unified interface that a user can view the identified legal obligations. In some embodiments, the legal obligations are identified using machine-learning. In these embodiments, the document management system trains and applies a machine-learned model configured to identify sections within contracts that correspond to legal obligations. The document management system applies the machine-learned model to a set of contract documents and accordingly identifies the legal obligations in the set of contract documents. In other embodiments, the legal obligations can be manually tagged, or can otherwise by identified by the document management system, and can be within a user interface (for instance in conjunction with information related to the obligations) for users to access and review.

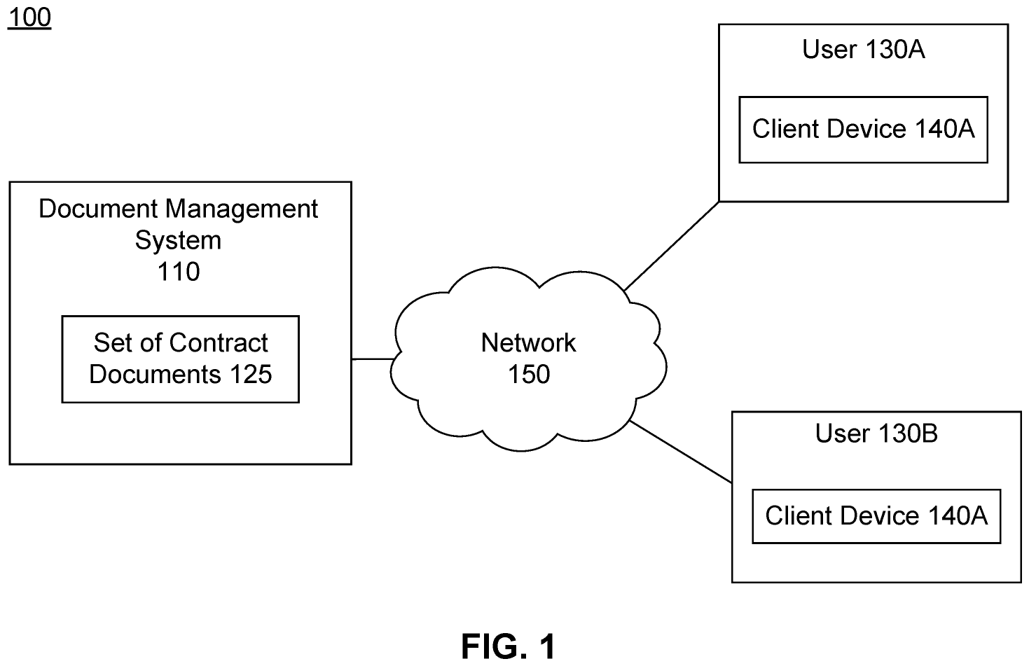

FIG. 1 is a high-level block diagram of a system environment 100 for a document management system 110, in accordance with an example embodiment. The system environment 100 enables users 130A-B to generate documents more efficiently with the document management system 110. As illustrated in FIG. 1, the system environment 100 includes a document management system 110, which may store a set of contract documents 125, users 130A-B, and corresponding client devices 140A-B, each communicatively interconnected via a network 150. In some embodiments, the system environment 100 includes components other than those described herein. For clarity, although FIG. 1 only shows two users 130A-B and two client devices 140A-B, alternative embodiments of the system environment 100 can have any number of users and client devices. For the purposes of concision, the web servers, data centers, and other components associated with an online system environment are not shown in FIG. 1.

The document management system 110 is a computer system (or group of computer systems) for storing and managing documents for the users 130A-B, for identifying legal obligations within a set of contract documents, and for modifying interfaces displayed by the client devices 140A-B to include information representative of the identified legal obligations, as described below. Using the document management system 110, users 130A-B can collaborate to create, edit, review, store, analyze, manage, and negotiate documents, such as the set of contract documents 125. Example contract documents 125 include employment agreements, purchase agreements, service agreements, financial agreements, master services agreements, intellectual property licensing agreements, rental agreements, mortgage agreements, and so on. The users 130A-B and/or entities associated with the users 130A-B may be parties to the contract documents 125.

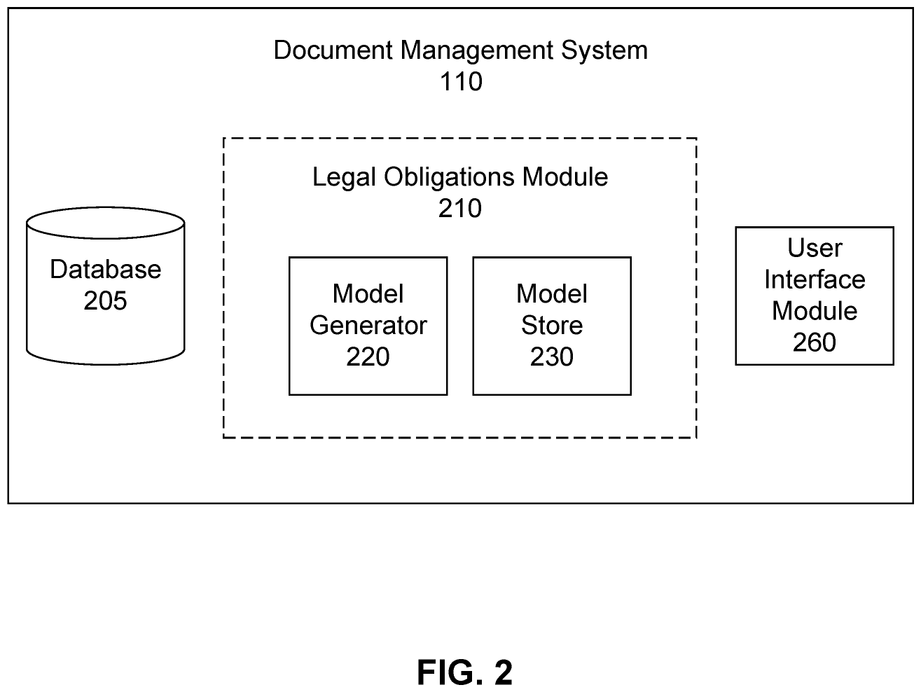

The document management system 110 can be a server, server group or cluster (including remote servers), or another suitable computing device or system of devices. In some implementations, the document management system 110 can communicate with client devices 140A-B over the network 150 to receive instructions and send documents (or other information) for viewing on client devices 140A-B. The document management system 110 can assign varying permissions to individual users 130A-B or groups of users controlling which documents each user can interact with and what level of control the user has over the documents they have access to. The document management system 110 will be discussed in further detail with respect to FIG. 2.

Users 130A-B of the client devices 140A-B can perform actions relating to documents stored within the document management system 110. Each client device 140A-B is a computing device capable of transmitting and/or receiving data over the network 150. Each client device 140A-B may be, for example, a smartphone with an operating system such as ANDROID® or APPLE® IOS®, a tablet computer, laptop computer, desktop computer, or any other type of network-enabled device from which secure documents may be accessed or otherwise interacted with. The client devices 140A-B each includes a camera application through which the users 130A-B can capture photographs of documents.

In some embodiments, the client devices 140A-B include an application through which the users 130A-B access the document management system 110, and through which one or more legal obligations associated with a set of documents corresponding to the users 130A-B can be displayed (for instance, within a dedicated “obligations” interface displayed by the client devices). The application may be a stand-alone application downloaded by the client devices 140A-B from the document management system 110. Alternatively, the application may be accessed by way of a browser installed on the client devices 140A-B and instantiated from the document management system 110. The application may be an e-sign application, enabling a user to create, view, modify, or electronically sign documents, which may then be provided to one or more additional entities via or stored by the document management system 110. In some embodiments, the application may be a word processing application, a contract lifecycle management application, a file directory/file storage application, or any other suitable application that enables the display of identified legal obligations within contract documents as described herein. The client devices 140A-B enables the users 130A-B to communicate with the document management system 110. For example, the client devices 140A-B enables the users 130A-B to upload, access, review, execute, and/or analyze documents within the document management system 110 via a user interface. In some implementations, entities not illustrated within FIG. 1 can include AIs, bots, scripts, or other automated processes set up to interact with the document management system 110, for instance to pre-process contract documents, to identify legal obligations within documents, to provide access to historical training documents, and the like. According to some embodiments, the users 130A-B are associated with permissions definitions defining actions users 130A-B can take within the document management system 110, or on documents, templates, permissions associated with other users and/or workflows.

The network 150 transmits data within the system environment 100. The network 150 may be a local area or wide area network using wireless or wired communication systems, such as the Internet. In some embodiments, the network 150 transmits data over a single connection (e.g., a data component of a cellular signal, or Wi-Fi, among others), or over multiple connections. The network 150 may include encryption capabilities to ensure the security of customer data. For example, encryption technologies may include secure sockets layers (SSL), transport layer security (TLS), virtual private networks (VPNs), and Internet Protocol security (IPsec), among others.

FIG. 2 is a high-level block diagram of a system architecture of the document management system 110, in accordance with an example embodiment. The document management system 110 includes a database 205, a legal obligations module 210, which includes a model generator 220 and a model store 230, and a user interface module 260. Computer components such as web servers, network interfaces, security functions, load balancers, failover servers, management and network operations consoles, and the like may not be shown so as to not obscure the details of the system architecture. The document management system 110 may contain more, fewer, or different components than those shown in FIG. 2 and the functionality of the components as described herein may be distributed differently from the description herein.

The database 205 stores information relevant to the document management system 110. The database 205 can be implemented on a computing system local to the document management system 110, remote or cloud-based, or using any other suitable hardware or software implementation. The data stored by the database 205 may include, but is not limited to, the set of contract documents 125, text of each contract document 125, legal obligations within the set of contract documents 125, historical contract documents, text (including clauses, terms, and legal obligations, for example) of the historical contract documents, information about users (e.g., the users 130A-B), client device identifiers (e.g., of the client devices 140A-B), and other information stored by the document management system 110. The document management system 110 can update information stored in the database 205 as new information is received, such as new contract documents and updates to machine-learned models stored in the model store 230.

The legal obligations module 210 identifies legal obligations within the set of contract documents 125. A legal obligation is a legally binding duty, promised by one or more parties to a contract, to perform an action. For example, legal obligations can arise in the context of service orders, work orders, payment dues, service level agreements, delivery dates, and so on. Failure to fulfil a legal obligation can lead to monetary penalties, and in some cases, civil liability. Entities or users that are parties to a plurality of contracts often agree to a large number of legal obligations. The legal obligations module 210 automatically identifies legal obligations in existing and newly created contract documents (e.g., which are in the set of contract documents 125) and presents them to a user of the document management system 110. The legal obligations module 210 includes the model generator 220 and the model store 230.

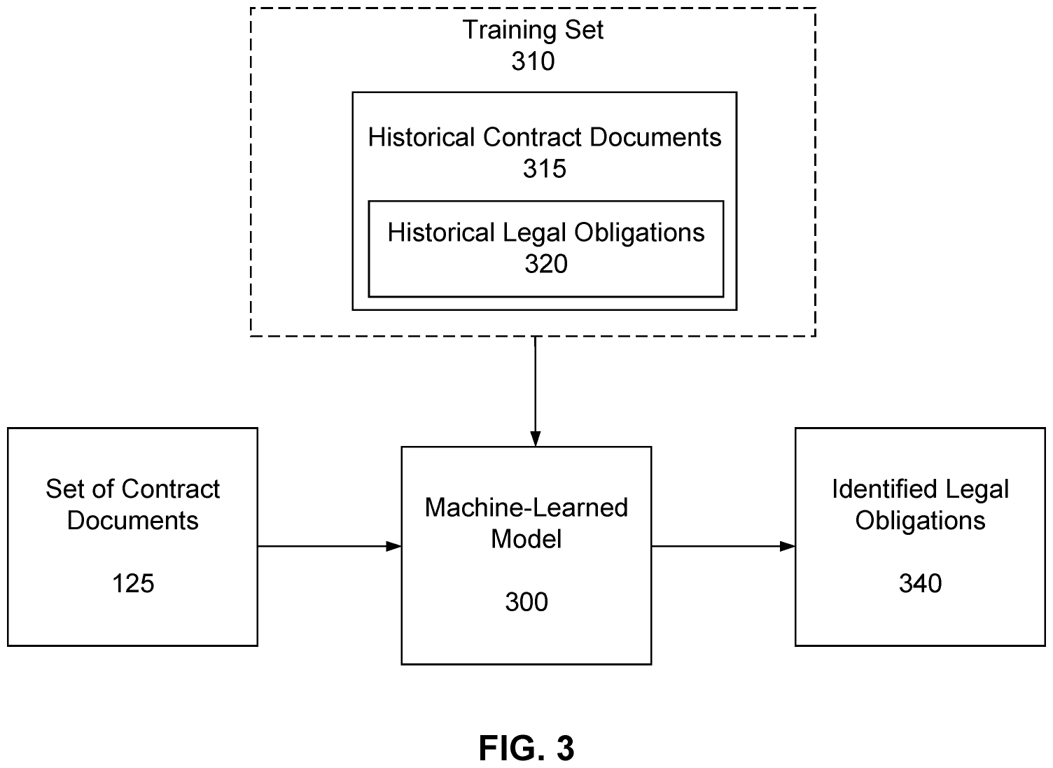

The model generator 220 trains machine-learned models, including a machine-learned model to identify portions of text within contract documents that correspond to legal obligations. The model generator 220 trains the machine-learned model using training data stored in the database 205; the training data comprises historical contract documents, each including portions of text corresponding to historical legal obligations. In some embodiments, the machine-learned model is trained to rank identified legal obligations based on their risk, due dates, monetary value, and so on. The model generator 220 can retrain models stored in the model store 230 periodically, or as new training data is received. Additional details about the machine-learned model are provided with respect to FIG. 3.

The historical contract documents can include contract documents associated with one or more entities and that include one or more legal obligations corresponding to each entity. Examples of historical contract documents include purchase agreements, service agreements, mortgage documents, employment agreements, and the like. The historical contract documents can include portions tagged as legal obligations. These portions may be manually tagged, for instance by a creator of the contract documents, by a party to the contract document, or to a third party that may or may not be associated with the historical contract documents. In some embodiments, the training data includes not just historical contract documents, but also contract documents associated with a particular user or set of entities, such as contract documents corresponding to manual feedback indicating incorrectly identified legal obligations, missed/unidentified legal obligations, or modifications to information associated with legal obligations. In some embodiments, the training data can be modified in response to user feedback, and to include contract documents associated with the user. The documents included within the training data (e.g., the historical documents or current documents associated with the user) can be documents of a particular document type or category, documents associated with a user similar to a user to which legal obligations are presented, documents associated with entities or jurisdictions associated with a user, all documents within a corpus of documents, or any other suitable type of document.

The model store 230 stores machine-learned models for the document management system 110, including those generated by the model generator 220. In some embodiments, the model store 230 may store various versions of models as they are updated over time. In other embodiments, the model store 230 may store multiple versions of a type of model to apply to different document types or to other variations of available inputs. In the example presented herein, the model store 230 stores the machine-learned model configured to identify legal obligations within the set of contract documents 125.

The user interface module 260 generates user interfaces for users (e.g., the users 130A-B) to interact with the document management system 110. The legal obligations module 210 presents the legal obligations identified by the machine-learned model via the user interface module 260. The order of presentation of the identified legal obligations depends on the ranking, determined by the machine-learned model.

Through the user interface module 260, the legal obligations module also presents information about each legal obligation. Such information includes, for example, a name of the legal obligation, a contract within which the identified legal obligation was identified, a description of the legal obligation, a risk level of the legal obligation, a priority of the legal obligation, a due date for the legal obligation, penalties for failing to perform the legal obligation, and a user to whom the legal obligation is assigned.

The user interface module 260 also facilitates user feedback regarding the ranking, priority, and/or accuracy of the identified legal obligations. Users may re-prioritize the legal obligations by providing input on the order in which the legal obligations are presented. Additionally, users may manually re-rank the legal obligations and provide input on their reasons for doing so. In another example, users may provide input on legal obligations that the machine-learned model failed to identify, or incorrectly identified, within the contract documents. In some embodiments, users may provide feedback on the information presented about each legal obligation. Users may manually change and/or add descriptions, risk levels, due dates, and/or users associated with each legal obligation.

The model generator 220 retrains the machine-learned model with the user feedback. The model generator 220 adds the user feedback to the training data. The contract documents and identified legal obligations corresponding to the user feedback are designated historical contract documents and historical legal obligations, respectively. Based on the user feedback, the machine-learned model is retrained to identify legal obligations within contract documents, rank each identified legal obligation, and output information about each identified legal obligation.

In addition to presenting legal obligations, the user interface module 260 provides a user interface for users to add, delete, or modify the contents of the set of contract documents 125, the historical contract documents, and other documents stored in the document management system 110. In some embodiments, the user interface module 260 provides a user interface that allows users to modify content such as text, images, links to outside sources of information such as databases, and the like.

### Identifying Legal Obligations Using Machine Learning

FIG. 3 illustrates training a machine-learned model 300 configured to identify legal obligations within the set of contract documents 125, in accordance with an example embodiment. FIG. 3 shows the set of contract documents 125, the machine-learned model 300, a training set 310, including historical contract documents 315 and historical legal obligations 320, and identified legal obligations 340. As discussed with respect to FIG. 2, the document management system 110 may generate and store the machine-learned model 300 with the model generator 220 and the model store 230, respectively. The model generator 220 trains the machine-learned model 300 using the training set 310; the trained machine-learned model 300 takes, as input, the set of contract documents 125, and identifies corresponding legal obligations 340. It should be noted that in some embodiments, the machine-learned model may be trained by the document management system 110 and provided to an entity that in turn applies to the machine-learned model to contract documents associated with the entity. Likewise, in some embodiments, the machine-learned model is trained by an entity other than the document management system 110 and is provided to an entity associated with the document management system for deployment. The principles of identifying legal obligations and populating an interface for the centralized display of legal obligation information described herein apply equally to each embodiment.

The training set 310 includes training documents 315, such as historical training documents that include historical legal obligations, and such as documents corresponding to an entity to which the entity has manually tagged legal obligations or other contract attributes, or to which the entity has provided feedback with regards to an identification of a legal obligation. Historical contract documents 315 are completed contracts to which a user (e.g., one of the users 130A-B) or an entity of the document management system 110 were parties in the past. The historical contract documents 315 may be specific to a user, an entity, and/or a type of contract document. Each historical contract document 315 includes one or more contract attributes such as one or more historical legal obligations 320. A historical legal obligation 320 is a legal obligation (e.g., a promise to perform one or more actions) that parties to the historical contract document 315 were bound to, or promised, in the past. Within each historical contract document 315, the portions of text corresponding to historical legal obligations 320 are labeled (e.g., by users of the document management system 110) accordingly.

The historical legal obligations 320 may also be ranked, for instance according to risk, which is dependent on one or more risk factors. For example, risk factors include an urgency, a monetary value, and/or a priority of the historical legal obligation 320. In other embodiments, the risk varies with a type of and/or parties to the historical document 315 from which the historical legal obligation 320 originated. In yet another embodiment, the risk is based on a user and/or type of entity associated with the historical legal obligation 320. The risk may be determined using a combination and/or all of the factors mentioned above. Users of the document management system 110 may provide input (e.g., via the user interface module 260) as to additional risk factors, as well as a risk level for each historical legal obligation 320. Historical legal obligations may also be ranked according to other factors, such as a due date associated with each obligation, a dollar amount associated with each obligation, a type of obligation, a number of counter-parties to a corresponding contract, a metric of how common or uncommon each obligation is, and the like.

For each labeled historical legal obligation 320, the training set 310 includes information associated with one or more contract attributes, such as a title of the corresponding historical contract document 315, a due date, a description, and penalties for failing to fulfil the historical legal obligation 320. Users of the document management system 110 may provide this information for each historical legal obligation 320. In some embodiments, the information associated with one or more contract attributes is automatically detected, for instance using a text-detection model generated by the model generator 220 and configured to identify contract attributes using optical character recognition, image processing and identification, or any other suitable operations. In practice, the machine-learned model 300 may be trained using one or more contract attributes in addition to legal obligations as features or signals that enable the machine-learned model to identify legal obligations within contract documents.

The training set 310 may be separated into a positive training set and a negative training set. The positive training set includes the portions of text in the historical contract documents 315 corresponding to the historical legal obligations 320, as well as their rankings. The negative training set includes portions of text or clauses in the historical contract documents 315 that do not correspond to historical legal obligations 320. The negative training set may include attributes of contracts that do not amount to legal obligations, such as a jurisdiction whose laws govern the contract, an expiration date of the contract, a monetary value of the contract, and so on.

The document management system 110 uses supervised or unsupervised learning to train the machine-learned model 300 using the positive and negative training sets. Different machine learning techniques may be used in various embodiments, such as linear support vector machines (linear SVM), boosting for other algorithms (e.g., AdaBoost), neural networks, logistic regression, naïve Bayes, memory based learning, random forests, bagged trees, decision trees, boosted trees, or boosted stumps. In training, the machine-learned model 300 learns to correlate a presence of one or more contract attributes within the historical contract documents 315 and portions of text corresponding to legal obligations 325 within the historical contract documents.

The trained machine-learned model 300 can identify legal obligations 340 within the set of contract documents 125. Specifically, the machine-learned model 300 identifies portions of text in the set of contract documents 125 corresponding to the legal obligations 340. The machine-learned model 300 also ranks each of the identified legal obligations 340 based on a level of risk. Examples of high priority—and therefore high ranked—legal obligations 340 include, but are not limited to, a legal obligation 340 that stipulates a several million dollar liability for failure to perform, a legal obligation 340 that has a nearing due date, and a legal obligation 340 that has one or more dependencies (e.g., action items and/or legal obligations that depend on the fulfilment of the legal obligation 340). The machine-learned model 300 also identifies information for each legal obligation 340, such as a name and/or description, due date, assigned user, and the contract document 125 within which the legal obligation 340 was identified. In some embodiments, the ranking of legal obligations is performed by the document management system 110 after the legal obligations are identified by the machine-learned model, based on one or more of the signals described above. In yet other embodiments, the machine-learned model is provided to an entity other than the document management system 110, which then ranks legal obligations identified by the machine-learned model.

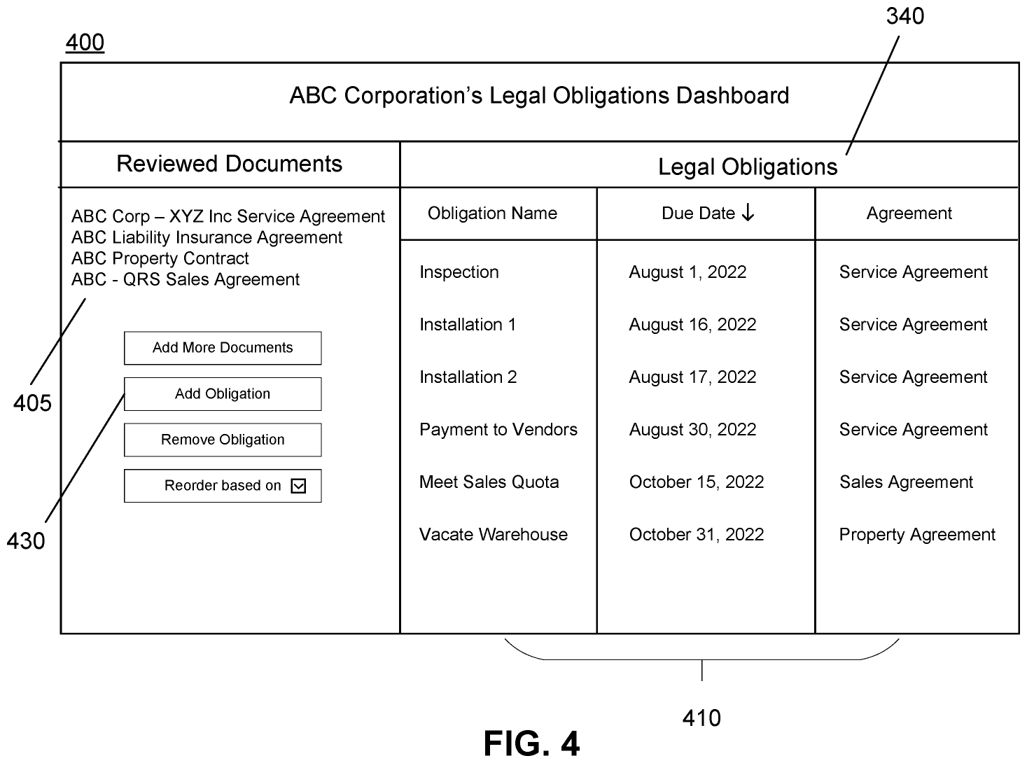

FIG. 4 illustrates an example interface 400 of the document management system that displays the legal obligations 340 identified by the machine-learned model 300, in accordance with an example embodiment. The interface 400 (e.g., generated by the user interface module 260) includes a set of contract documents 405, the identified legal obligations 340, information 410 about the identified legal obligations 340, and user input controls 430.

As described with respect to FIGS. 2 and 3, the document management system 110 analyzes the set of contract documents 125 for legal obligations using the machine-learned model 300. The interface 400 presents the set of contract documents 405 within which the legal obligations 340 were identified.

The interface 400 also presents each of the identified legal obligations 340 and corresponding information 410. The presented information 410 includes a name, due date, and document corresponding to each legal obligation 340. In some embodiments, the information 410 further includes one or more users of the document management system 110, monetary values, penalties, risks, and/or counter parties associated with the legal obligation 340.

The interface 400 presents the legal obligations 340 based on their rankings, which, in this example, is per due date. In other embodiments, the legal obligations 340 are ranked based on other priorities of the user and/or entity of the document management system 110. In other embodiments, the legal obligations 340 are ordered on the interface 400 based on factors other than ranking or levels of risk. For example, the legal obligations 340 can be presented in an order based on dates agreed to within each legal obligation 340 and/or a date of performance of each legal obligation 340. In other embodiments, the legal obligations 340 may be ordered based on the types of and/or parties to documents from which each legal obligation 340 originates, characteristics of an entity (e.g., size, location, revenue, corporate structure) associated with each legal obligation 340, a jurisdiction associated with each legal obligation 340, a monetary value associated with each legal obligation 340, a difficulty of performance of each legal obligation 340, and so on.

The interface 400 includes, in some embodiments, user input controls 430 through which users can provide feedback to the document management system 110. Users can, for example, add more documents to review for legal obligations, manually add legal obligations that should have been identified within the contract documents 405, remove identified legal obligations 340 that were incorrectly identified, reorder the identified legal obligations 340, and so on. The document management system 110 retrains the machine-learned model 300 based on received user feedback.

### Process for Identifying Legal Obligations

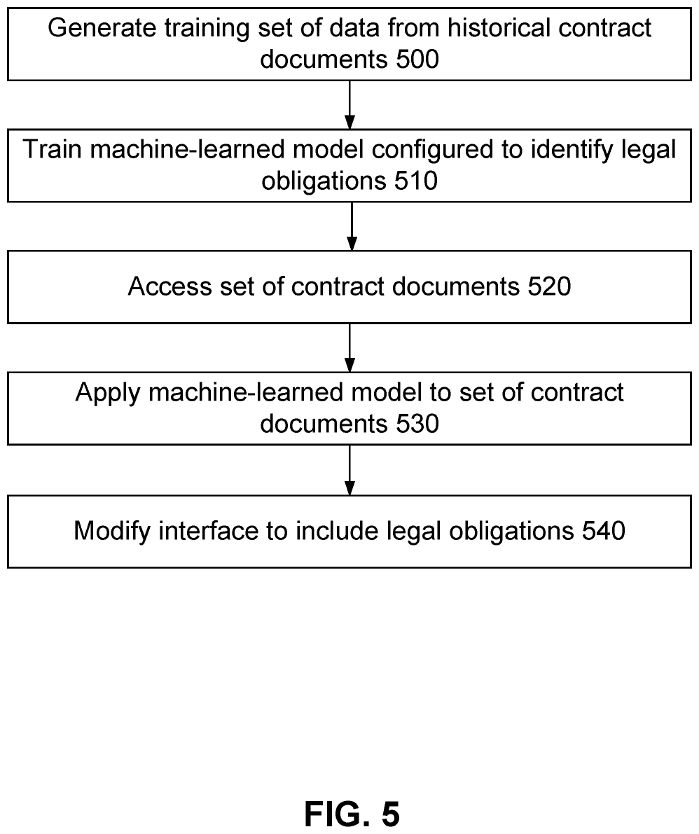

FIG. 5 illustrates an example process for identifying legal obligations in a set of contract documents, in accordance with an example embodiment.

The document management system (e.g., the document management system 110) generates 500 a training set of data including a number of historical contract documents (e.g., the historical contract documents 315). Each historical contract document includes one or more portions of text corresponding to a historical legal obligation (e.g., the historical legal obligations 320).

The document management system trains 510 a machine-learned model (e.g., the machine-learned model 300) that is configured to identify portions of text within contract documents corresponding to legal obligations.

The document management system accesses 520 a set of contract documents (e.g., the set of contract documents 125) associated with an entity and/or user of the document management system.

The document management system applies 530 the machine-learned model to the set of contract documents, the output of which is identified portions of text within each contract document corresponding to a set of legal obligations (e.g., the identified legal obligations 340).

The document management system modifies 540 an interface (e.g., the interface 400) to include information (e.g., the information 410) about the set of identified legal obligations.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1-20. (canceled)

21. A computer-implemented method, comprising:
receiving, using at least one processor circuitry, one or more electronic documents;
applying, using the at least one processor circuitry, a trained machine-learned model to the one or more electronic documents, the machine-learned model has been trained using one or more historical obligations in a plurality of historical electronic documents;
identifying, using the at least one processor circuitry, based on the applying of the machine-learned model, one or more portions of text within the one or more electronic documents corresponding to one or more obligations; and
modifying, using the at least one processor circuitry, an interface to include information representative of the one or more obligations within the one or more electronic documents identified by the machine-learned model.

22. The method of claim 21, further comprising ranking each of the one or more obligations.

23. The method of claim 22, wherein the modifying includes ordering each obligation in the one or more obligations based on the ranking, wherein the ranking is based on a level of risk associated with each obligation in the one or more obligations.

24. The method of claim 23, wherein the level of risk is based on at least one of the following: the information representative of the one or more obligations, the information including at least one of: a date, a priority, a monetary value, a type of electronic document in the one or more electronic documents, an entity associated with each obligation in the one or more obligations; an input from a user, and any combinations thereof.

25. The method of claim 21, wherein the machine-learned model is configured to be retrained based on an input from a user received via the interface.

26. The method of claim 25, wherein the input from the includes an identification of at least one obligation that the machine-learned model failed to identify or incorrectly identified;
wherein the machine-learned model is configured to be retrained using the identified at least one obligation that the machine-learned model failed to identify or incorrectly identified.

27. The method of claim 21, wherein the applying includes
selecting the trained machine-learned model from a plurality of machine-learned models based on at least one of: a type of the one or more electronic documents, a type of the one or more obligations, and any combinations thereof, and
applying the selected machine-learned model to the one or more electronic documents.

28. The method of claim 21, wherein the machine-learned model is configured to be trained using at least one of: a positive training, a negative training, and any combinations thereof;
wherein the positive training is based on at least one attribute of the one or more electronic documents that corresponds to at least one obligation;
wherein the negative training is based on at least another attribute of the one or more electronic documents that does not correspond to at least one obligation.

29. A non-transitory computer-readable storage medium storing executable instructions that, when executed by at least one processor circuitry, cause the at least one processor circuitry to:
access a trained machine-learned model to identify one or more portions of text within one or more electronic documents corresponding to one or more obligations, the machine-learned model has been trained using one or more portions of text corresponding to one or more historical obligations in a plurality of historical electronic documents;
access the one or more electronic documents;
identify, based on applying the machine-learned model to the one or more electronic documents, one or more portions of text within the one or more electronic documents corresponding to one or more obligations; and
modify an interface to include information representative of the one or more obligations.

30. The non-transitory computer-readable storage medium of claim 29, wherein the instructions cause the at least one processor circuitry to rank the one or more obligations.

31. The non-transitory computer-readable storage medium of claim 30, wherein modification of the interface includes ordering the one or more obligations based on the rank, wherein the rank is based on a level of risk associated with each obligation in the one or more obligations.

32. The non-transitory computer-readable storage medium of claim 31, wherein the level of risk is based on at least one of: the information representative of the one or more obligations, the information including at least one of: a date, a priority, a monetary value, a type of electronic document in the one or more electronic documents, an entity associated with each obligation in the one or more obligations; an input from a user; and any combinations thereof.

33. The non-transitory computer-readable storage medium of claim 29, wherein the machine-learned model is configured to be retrained based on an input from a user received via the interface.

34. The non-transitory computer-readable storage medium of claim 33, wherein the input from the user includes an identification of at least one obligation that the machine-learned model failed to identify or incorrectly identified, wherein the machine-learned model is configured to be retrained using the identified at least one obligation that the machine-learned model failed to identify or incorrectly identified.

35. The non-transitory computer-readable storage medium of claim 33, wherein the input from the user includes at least one of: a manual modification to a description, a risk level, a due date, a party to the one or more obligations, and any combinations thereof.

36. The non-transitory computer-readable storage medium of claim 29, wherein the applying includes
selecting the trained machine-learned model from a plurality of machine-learned models based on at least one of: a type of the one or more electronic documents, a type of the one or more obligations, and any combinations thereof, and
applying the selected machine-learned model to the one or more electronic documents.

37. The non-transitory computer-readable storage medium of claim 29, wherein the machine-learned model is configured to be trained using at least one of: a positive training, a negative training, and any combinations thereof,
wherein the positive training is based on at least one attribute of the one or more electronic documents that corresponds to at least one obligation;
wherein the negative training is based on at least another attribute of the one or more electronic documents that does not correspond to at least one obligation.

38. A document management system, comprising:
at least one processor circuitry; and
a non-transitory computer-readable storage medium storing executable instructions that, when executed, cause the at least one processor circuitry to:
receive one or more electronic documents;
apply a trained machine-learned model to the one or more electronic documents, the machine-learned model has been trained using one or more historical obligations in a plurality of historical electronic documents;
identify, based on applying of the machine-learned model, one or more portions of text within the one or more electronic documents corresponding to one or more obligations; and
modify an interface to include information representative of the one or more obligations within the one or more electronic documents identified by the machine-learned model.

39. The system of claim 38, wherein the instructions cause the at least one processor circuitry to rank each obligation in the one or more obligations.

40. The system of claim 39, wherein modifying the interface includes ordering each obligation in the one or more obligations based on the rank, wherein the rank is based on a level of risk associated with each obligation in the one or more obligations.
